(19) United States
(12) Patent Application Publication
(10) Pub. No.: US 2025/0352950 A1
(43) Pub. Date: Nov. 20, 2025

(54) METHOD FOR PURIFYING A COMPOSITION COMPRISING HYDROGEN PEROXIDE

(71) Applicant: ARKEMA FRANCE, Colombes (FR)

(72) Inventor: Myriam GERBIER, Pierre-Benite (FR)

(73) Assignee: ARKEMA FRANCE, Colombes (FR)

(21) Appl. No.: 18/868,605

(22) PCT Filed: Jul. 27, 2023
(86) PCT No.: PCT/FR2023/051189

§ 371 Date: Nov. 22, 2024

(30) Foreign Application Priority Data
Jul. 28, 2022 (FR) 2207775

(51) Int. Cl. B01D 61/02; B01D 61/48; B01D 61/58; B01D 71/56; C02F 1/44; C02F 1/469; C02F 103/34

(52) U.S. Cl. CPC B01D 61/026; B01D 61/48; B01D 61/58; B01D 71/56; C02F 1/441; C02F 1/4695; B01D 2321/2083; B01D 2325/26; C02F 2103/346

(57) ABSTRACT

The present invention relates to a process for the purification of an aqueous hydrogen peroxide solution, comprising at least one treatment on a reverse osmosis membrane and at least one electrodeionization treatment. The invention also relates to a process for the preparation of an aqueous hydrogen peroxide solution, comprising at least one stage of synthesis of an aqueous hydrogen peroxide solution, at least one treatment on a reverse osmosis membrane and at least one electrodeionization treatment of said solution. The invention also relates to an aqueous hydrogen peroxide solution capable of being obtained by the purification process or the preparation process, as are defined above.

The present invention relates to a process for the purification of an aqueous hydrogen peroxide solution, comprising at least one treatment on a reverse osmosis membrane and at least one electrodeionization treatment.

The invention also relates to a process for the preparation of an aqueous hydrogen peroxide solution, comprising at least one stage of synthesis of an aqueous hydrogen peroxide solution, at least one treatment on a reverse osmosis membrane and at least one electrodeionization treatment of said solution.

The invention also relates to an aqueous hydrogen peroxide solution capable of being obtained by the purification process or the preparation process, as are defined above.

Another subject matter of the invention is the use of said aqueous hydrogen peroxide solution as cleaning agent in the field of electronics.

Aqueous hydrogen peroxide solutions can be used in varied technical fields, for example in the textile field, the food processing industry, in particular for disinfecting or sterilizing packaging materials in contact with foodstuffs, or also in the field of electronics.

In the field of electronics, aqueous hydrogen peroxide solutions can be used during the phases of cleaning and etching semiconductor wafers. To do this, the aqueous hydrogen peroxide solution employed has to exhibit a high degree of purity, that is to say residual contents of inorganic impurities, cations and anions, and of organic impurities which are sufficiently low.

However, the processes generally employed in the synthesis of crude aqueous hydrogen peroxide solution, for example an anthraquinone process, result in the presence of inorganic impurities, cations and anions, and organic impurities in contents which are significantly too high for applications as demanding in terms of purity as in the field of electronics.

In addition, the hydrogen peroxide can be contaminated by metal impurities, such as iron (Fe), copper (Cu) or chromium (Cr), during its transportation and/or its storage due to its corrosive nature on contact with metal surfaces.

Thus, the presence of inorganic and organic impurities, resulting from synthesis processes, and contaminants, resulting from transportation and/or storage, can have an impact on the quality, the crystal structure and the purity of semiconductor wafers.

Thus, one of the objectives of the present invention is to provide a process for the purification of aqueous hydrogen peroxide solutions capable of significantly reducing the residual contents of impurities, in particular inorganic and organic impurities, in order to make possible the use of these solutions in applications in the field of electronics, in particular during the phase of cleaning and/or etching semiconductor wafers.

In other words, one of the aims of the present invention is to significantly reduce, indeed even to remove, the impurities likely to at least result from a process for the synthesis of hydrogen peroxide and, possibly, from the corrosion by the aqueous hydrogen peroxide solution of metal surfaces during its transportation and/or storage.

In particular, one of the aims of the present invention is to reduce the cationic and anionic inorganic impurities, such as nitrates and sodium, and also the organic impurities, in particular the content of total organic carbon (TOC).

A subject matter of the present invention is thus in particular a process for the purification of an aqueous hydrogen peroxide solution, comprising at least one treatment on a reverse osmosis membrane and at least one electrodeionization treatment, the membrane being chosen from the group consisting of a membrane of polyamide, cellulose, polypiperazine, polyacrylonitrile and polysulfone type.

The process according to the invention thus exhibits the advantage of significantly reducing, indeed even of removing, the content of organic impurities, in particular the content of total organic carbon (TOC), and also the content of cationic and anionic inorganic impurities, in aqueous hydrogen peroxide solutions.

Preferably, the process according to the invention results in the minimization, indeed even in the removal, of the content of organic impurities, in particular the content of total organic carbon (TOC), and the content of inorganic impurities, in particular alkaline earth metals, especially sodium, the cationic ions chosen from the group consisting of metal ions, alkaline earth ions other than sodium, alkali metal ions and non-metallic ions, anionic ions chosen from the group consisting of chlorides, sulfates, phosphates and nitrates, and also silicon.

Preferably, the process according to the invention makes it possible to minimize, indeed even to remove, the content of inorganic impurities selected from the group consisting of sodium and nitrates, chlorides, sulfates, phosphates, silicon, iron and chromium, in particular nitrates and sodium, and organic impurities, in particular the content of total organic carbon (TOC).

The process according to the invention makes it possible in particular to result in a particularly advantageous degree of removal of the abovementioned impurities, for example of at least 95%, in particular of at least 97%, indeed even of close to 99%.

Advantageously, the process according to the invention makes it possible in particular to result in a degree of removal of close to 98% of the nitrates present in an aqueous hydrogen peroxide solution.

The process according to the invention makes it possible to result in aqueous hydrogen peroxide solutions having a very high degree of purity, thus making it possible for them to be used in applications in the field of electronics, for example during the phases of cleaning and etching semiconductor wafers.

In other words, the process according to the invention results in specialty grades of aqueous hydrogen peroxide solution used in electronic applications.

Thus, the process according to the invention reinforces the purity conditions under which the applications in the field of electronics are carried out; in particular, the aqueous hydrogen peroxide solutions obtained by a process according to the invention do not have an impact on the quality, the crystal structure and the purity of semiconductor wafers.

In other words, the risks of contamination with organic and inorganic impurities associated with the use of aqueous hydrogen peroxide solutions are minimized by virtue of the process according to the invention.

Moreover, the process according to the invention advantageously makes it possible to satisfactorily reduce, indeed even to remove, the contaminants resulting from the corrosion by the aqueous hydrogen peroxide solution of metal surfaces during its transportation and/or its storage.

The aqueous hydrogen peroxide solution can thus be safely transported and stored under standard conditions without its degree of purity being irreversibly impacted for applications in the field of electronics.

Another subject matter of the invention is a process for the preparation of an aqueous hydrogen peroxide solution, comprising:
at least the production of an aqueous hydrogen peroxide solution, preferably by an anthraquinone process,
at least one treatment on a membrane, as described above, and at least one electrodeionization treatment of the aqueous hydrogen peroxide solution, as described above.

Thus, the purification process according to the invention can advantageously be carried out following a process targeted at manufacturing an aqueous hydrogen peroxide solution.

In addition, the invention also relates to an aqueous hydrogen peroxide solution capable of being obtained by a purification process, as described above, or a preparation process, as defined above.

Advantageously, the aqueous hydrogen peroxide solution, obtained or purified, contains a content of cationic and anionic inorganic impurities, preferably from the group consisting of nitrates, sodium, silicon, chromium and iron, and a content of organic impurities, in particular a content of total organic carbon, which are significantly reduced.

Likewise, the present invention also relates to the use of an aqueous hydrogen peroxide solution as described above in the field of electronics, preferably as cleaning agent.

Other characteristics and advantages of the invention will become more clearly apparent on reading the description, the figure and the examples which follow.

In that which follows, and unless otherwise indicated, the limits of a range of values are included in this range, in particular in the expressions “of between . . . and . . . ” and “ranging from . . . to . . . ”.

The expression “at least one” is equivalent to the expression “one or more” and can be replaced.

### Process for the Purification of the Aqueous Hydrogen Peroxide Solution

The aqueous hydrogen peroxide solution, intended to be treated by the process according to the invention, preferably comprises a content of hydrogen peroxide ranging from 30% to 70% by weight, preferably ranging from 30% to 60% by weight and more preferentially still ranging from 45% to 60% by weight, with respect to the total of the aqueous solution.

As indicated above, the purification process according to the invention comprises at least one treatment on a reverse osmosis membrane and at least one electrodeionization treatment, the membrane being chosen from the group consisting of a membrane of polyamide, cellulose, polypiperazine, polyacrylonitrile and polysulfone type.

In other words, the process according to the invention comprises the implementation of one or more purification stages of a reverse osmosis membrane separation method, combined with one or more purification stages of an electrodeionization method.

The process according to the invention makes it possible to reduce, indeed even to remove, the content of organic impurities and the content of cationic and anionic inorganic impurities.

The content of organic impurities is in particular the content of total organic carbon (TOC).

The content of total organic carbon (TOC) can be analyzed with a standard method, in particular with a TOC analyzer.

The inorganic impurities are in particular chosen from the group consisting of sodium, metal ions, alkaline earth ions other than sodium, non-metallic ions, chlorides, sulfates, phosphates and nitrates, and also silicon, preferably chosen from the group consisting of nitrates and sodium.

The content of cationic impurities can be analyzed, for example, by inductively coupled plasma mass spectrometry.

The content of anionic impurities can be analyzed, for example, by ion chromatography (ion-exchange chromatography).

As indicated above, the cationic and anionic inorganic impurities, and also the organic impurities, can originate from the process for obtaining the aqueous hydrogen peroxide solution, preferably from an anthraquinone process.

In accordance with the present invention, the treatment on a reverse osmosis membrane and the electrodeionization treatment are distinct treatments and can be carried out sequentially in a different order.

By way of example, the aqueous hydrogen peroxide solution can be purified by at least one, preferably one or two, more preferentially at least two, treatment(s) on a reverse osmosis membrane, then by at least one electrodeionization treatment.

Alternatively, the aqueous hydrogen peroxide solution can be purified by at least one electrodeionization treatment, then by at least one, preferably one or two, treatment(s) on a reverse osmosis membrane.

Preferably, the purification process comprises successively at least one, preferably one or two, more preferentially at least two, treatment(s) on a reverse osmosis membrane and at least one electrodeionization treatment, of the aqueous hydrogen peroxide solution.

In other words, the process according to the invention preferably comprises, successively:
at least one treatment on a reverse osmosis membrane of an aqueous hydrogen peroxide solution, the membrane being chosen from the group consisting of a membrane of polyamide, cellulose, polypiperazine, polyacrylonitrile and polysulfone type,
at least one electrodeionization treatment of the permeate resulting from the treatment(s) on a membrane.

The treatment on a reverse osmosis membrane and the electrodeionization treatment can advantageously be carried out at a temperature of less than 20° C., preferably at a temperature of less than 15° C.

### Treatment on a Membrane

The purification process according to the invention comprises one or more treatments on a membrane of the aqueous hydrogen peroxide solution, preferably one or two treatments on a membrane.

Preferably, the purification process according to the invention comprises at least two treatments on a membrane.

The treatment on a membrane is a treatment on a reverse osmosis membrane.

Preferably, the purification process according to the invention comprises one or more treatments on a reverse osmosis membrane of the aqueous hydrogen peroxide solution, more preferentially one or two treatments on a reverse osmosis membrane, preferentially again at least two treatments on a reverse osmosis membrane.

The reverse osmosis membrane is chosen from the group consisting of a membrane of polyamide, cellulose, polypiperazine, polyacrylonitrile and polysulfone type; more preferentially, the reverse osmosis membrane is a membrane of polyamide type.

The membrane of polyamide type advantageously exhibits a better chemical resistance to hydrogen peroxide and to the impurities present in the hydrogen peroxide solution.

Preferably, the treatment on a membrane is carried out at a temperature of less than 30° C., more preferentially of less than 20° C.

Preferably, the treatment on a membrane is carried out at a temperature of greater than 0° C., more preferentially of greater than 5° C.

Preferably, the treatment on a membrane is carried out at a pressure ranging from 10 to 70 bar, more preferentially ranging from 20 to 40 bar.

Preferably, the permeation flux during the treatment on a membrane can vary from 10 to 200 l/h·m², preferably from 30 to 120 l/h·m².

Preferably, the volume concentration factor (VCF), corresponding to the ratio of the feed flow rate of the aqueous hydrogen peroxide solution to the concentrate flow rate (i.e. the flow of water discharged during the separation treatment), varies from 1.1 to 15, more preferentially from 2 to 10.

### Electrodeionization Treatment

Preferably, the process according to the invention comprises an electrodeionization treatment of an aqueous hydrogen peroxide solution.

Preferably, the electrodeionization treatment is carried out by means of an electrodeionization module comprising an anode (1), a cathode (2), a purification compartment (3), arranged between two concentration compartments (4) and (5), the walls of which are provided with a first anion-exchange membrane (6) and a first cation-exchange membrane (7).

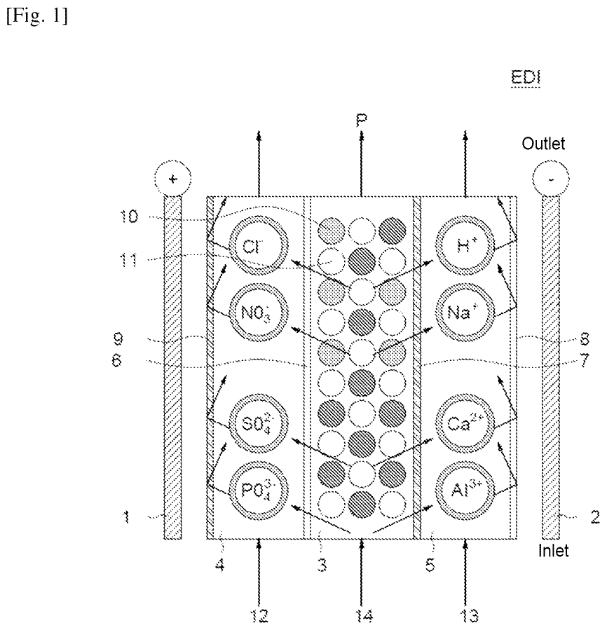

The electrodeionization treatment can be carried out with an electrodeionization module, one embodiment of which is described in FIG. 1.

Preferably, the electrodeionization treatment is carried out at a temperature of less than 20° C., more preferentially of less than 15° C.

Preferably, the feed flow rate of the electrodeionization module varies according to the capacity of the module.

Preferably, the flow rate of the concentrate at the outlet of the electrodeionization module varies according to the capacity of the module.

As indicated above, FIG. 1 represents a particular embodiment of the electrodeionization module.

In FIG. 1, the electrodeionization EDI module comprises an anode (1) and a cathode (2), so that, during the application of a source of direct current, an electric field is applied across all of the components of the module between the anode (1) and the cathode (2).

Between the anode (1) and the cathode (2), the electrodeionization module additionally comprises a purification compartment (3) in which the aqueous hydrogen peroxide solution (14) moves vertically in the direction shown in FIG. 1.

The purification compartment (3), located centrally within the module, is arranged between two adjacent compartments, referred to as concentration compartments (4) and (5). In other words, the concentration compartments (4) and (5) are located on either side of the purification compartment (3).

The purification compartment is arranged between a first anion-exchange membrane (6) and a first cation-exchange membrane (7). The anion-exchange membrane (6) is contiguous with the concentration compartment (12) and the cation-exchange membrane (7) is contiguous with the concentration compartment (13).

In accordance with this configuration, only the ions contained in the aqueous hydrogen peroxide solution can pass through these membranes (6) and (7), the liquid part remaining blocked in the purification compartment (3).

The electrodeionization EDI module additionally comprises a second anion-exchange membrane (8) arranged between the second concentration compartment (5) and the cathode (2). The second anion-exchange membrane (8) is laid out so as to be in contact with the wall of the second concentration compartment (5). In this way, the second concentration compartment (5) is arranged between the first cation-exchange membrane (7) and the second anion-exchange membrane (8) so that the walls of the second concentration compartment (5) are contiguous with the first membrane (8) and the second membrane (7).

The electrodeionization EDI module additionally comprises a second cation-exchange membrane (9) arranged between the first concentration compartment (4) and the anode (1). The second cation-exchange membrane (9) is laid out so as to be in contact with the wall of the first concentration compartment (4). In this way, the first concentration compartment (4) is arranged between the first anion-exchange membrane (6) and the second cation-exchange membrane (9) so that the walls of the first concentration compartment (4) are contiguous with the first membrane (6) and the second membrane (9).

The purification compartment (3) is additionally filled with a bed of resins which is supplied with a mixture of anionic ion-exchange resins (11) and of cationic ion-exchange resins (10). Such resins are regenerated electrochemically.

Thus, during the movement of the aqueous hydrogen peroxide solution (14), the cationic ion-exchange resins (10) can adsorb the cations present in the solution, for example the sodium, calcium, aluminum ions and/or the hydrogen ion, and shift them to the first cation-exchange membrane (7), under the influence of the applied electric field, so as to convey them into the second concentration compartment (5).

Once in the second concentration compartment (5), the cations cannot reach the cathode (2) because they are blocked by the second anion-exchange membrane (8) contiguous with the wall of the second concentration compartment (5).

Similarly, the anionic ion-exchange resins (11) can adsorb the anions present in the aqueous hydrogen peroxide solution, for example the chloride, nitrate, sulfate and phosphate ions, and shift them to the first anion-exchange membrane (6), under the influence of the applied electric field, so as to convey them into the first concentration compartment (4).

Once in the first concentration compartment (4), the anions cannot reach the anode (1) because they are blocked by the second cation-exchange membrane (9) contiguous with the wall of the first concentration compartment (4).

In this way, the presence of cations and anions within the aqueous hydrogen peroxide solution, moving in the purification compartment, is continuously reduced to be transferred into the adjacent concentration compartments (4) and (5).

At the same time, water can be introduced into each of the concentration compartments (4) and (5) so as to remove respectively the anionic entities and the cationic entities from the concentration compartments.

Thus, the diluate obtained following the electrodeionization treatment originates from the purification compartment (3) of the electrodeionization module and the concentrate originates from the concentration compartments (4) and (5).

In particular, the first concentrate and the second concentrate can be discharged respectively through the outlets of each of the concentration compartments (4) and (5).

Preferably, the feed flow rates in the dilution and concentration compartments can be equivalent or exhibit a ratio of 5/10, preferably 3/10, more preferentially 1/10, for the concentrate/diluate flows.

Preferably, the purification compartment (3) of the electrodeionization module is fed with the permeate from the treatment on a membrane, i.e. the aqueous hydrogen peroxide solution which has already been purified by one or more treatments on a reverse osmosis membrane, preferably one or two treatments on a reverse osmosis membrane, more preferentially at least two treatments on a reverse osmosis membrane.

Preferably, the purification process according to the invention does not comprise, before the treatment(s) on a reverse osmosis membrane, a stage of treatment on an ion-exchange resin.

Alternatively, the purification process according to the invention may not comprise a stage of treatment on an ion-exchange resin.

Within the meaning of the present invention, the stage of ion-exchange resin treatment is different from the stage of electrodeionization treatment.

Preferably, the aqueous hydrogen peroxide solution, after purification by the process according to the invention, comprises a nitrate content of less than 3 ppm, preferably of less than 2 ppm, more preferentially of less than 1 ppm.

Advantageously, the aqueous hydrogen peroxide solution, after purification by the process according to the invention, comprises a nitrate content of less than 0.5 ppm, better still of less than 0.3 ppm.

Preferably, the aqueous hydrogen peroxide solution, after purification by the process according to the invention, comprises a content of organic impurities, in particular a content of total organic carbon (TOC), of less than 6 ppm, a nitrate content of less than 0.3 ppm and a sodium content of less than 400 ppb, and optionally a chromium content of less than 0.5 ppb and an iron content of less than 2 ppb.

More preferentially, the aqueous hydrogen peroxide solution, after purification by the process according to the invention, comprises a content of organic impurities, in particular a content of total organic carbon (TOC), of less than 5 ppm, a nitrate content of less than 0.3 ppm and a sodium content of less than 200 ppb, and optionally a chromium content of less than 0.5 ppb and an iron content of less than 2 ppb.

Thus, the process according to the invention makes it possible to obtain a high degree of purity of an aqueous hydrogen peroxide solution and is particularly effective with regard to the nitrate impurities.

### Process for Obtaining an Aqueous Hydrogen Peroxide Solution

The present invention also relates to a process for the preparation of an aqueous hydrogen peroxide solution, comprising:
at least the production of an aqueous hydrogen peroxide solution, preferably by an anthraquinone process,
at least one treatment on a reverse osmosis membrane and at least one electrodeionization treatment of the aqueous hydrogen peroxide solution, such as are described above, the membrane being chosen from the group consisting of a membrane of polyamide, cellulose, polypiperazine, polyacrylonitrile and polysulfone type.

The process thus results in an aqueous hydrogen peroxide solution having an improved degree of purity.

According to the present invention, the production stage results in a crude aqueous hydrogen peroxide solution.

The aqueous hydrogen peroxide solution produced before purification can comprise a content of hydrogen peroxide ranging from 30% to 70% by weight, preferably ranging from 30% to 60% by weight and more preferentially still ranging from 45% to 60% by weight, with respect to the total of the aqueous solution.

Preferably, the preparation process additionally comprises, before carrying out the purification process according to the invention, one or more purification stages chosen from the group consisting of a liquid-liquid extraction, a treatment on an adsorption resin and a distillation.

Preferably, the purification process according to the invention does not comprise, before the treatment(s) on a reverse osmosis membrane, a stage of treatment on an ion-exchange resin.

Alternatively, the purification process according to the invention may not comprise a stage of treatment on an ion-exchange resin.

### Aqueous Hydrogen Peroxide Solution

Another subject matter of the invention is an aqueous hydrogen peroxide solution capable of being obtained by a purification process, as described above, or a manufacturing process, as defined above.

Preferably, the aqueous hydrogen peroxide solution comprises a nitrate content of less than 3 ppm, preferably a nitrate content of less than 2 ppm, more preferentially a nitrate content of less than 1 ppm.

Advantageously, the aqueous hydrogen peroxide solution comprises a nitrate content of less than 3 ppm, preferably of less than 2 ppm, more preferentially of less than 1 ppm. The aqueous hydrogen peroxide solution preferentially comprises a content of organic impurities, in particular a content of total organic carbon (TOC), of less than 6 ppm, a nitrate content of less than 0.3 ppm and a sodium content of less than 400 ppb, and optionally a chromium content of less than 0.5 ppb and an iron content of less than 2 ppb.

Preferably, the aqueous hydrogen peroxide solution preferentially comprises a content of organic impurities, in particular a content of total organic carbon (TOC), of less than 5 ppm, a nitrate content of less than 0.3 ppm and a sodium content of less than 200 ppb, and optionally a chromium content of less than 0.5 ppb and an iron content of less than 0.5 ppb.

Moreover, the aqueous hydrogen peroxide solution is advantageously used, in the field of electronics, preferably as cleaning agent, preferably for the cleaning of semiconductor wafers.

### Use

The present invention also relates to the use of an aqueous hydrogen peroxide solution, as described above, in the field of electronics, preferably as cleaning agent.

Preferably, the aqueous hydrogen peroxide solution is used as a cleaning agent for semiconductor wafers.

The following examples serve to illustrate the invention without, however, exhibiting a limiting nature.

### EXAMPLES

### Example 1

Crude aqueous hydrogen peroxide solution at 60% by weight in water, resulting from an anthraquinone process, is subjected to filtration on membranes.

The membrane separation is carried out by means of polyamide reverse osmosis membranes, at a temperature of 15° C. and a pressure of 30 bar.

The volume concentration factor (VCF) applied is 8.

The permeate thus obtained is subsequently subjected to an electrodeionization treatment, at a temperature of 15° C., carried out with an electrodeionization module.

The electrodeionization module, in particular as described in FIG. 1, is used with a diluate feed flow rate of 3 l/h and a concentrate flow rate of 1 l/h.

The quantitative determination of the elements shown in the table below leads to the following results:

TABLE 1

| | TOC | NO₃⁻ | Na | Cr | Fe | Si |
|---|---|---|---|---|---|---|
| Purification method | (ppm) | (ppm) | (ppb) | (ppb) | (ppb) | (ppm) |
| Aqueous hydrogen peroxide solution | 276 | 17.4 | 25 000 | 142 | 583 | 133 |
| after production process and | | | | | | |
| before purification (crude product) | | | | | | |
| Diluate resulting from the | 7 | <0.3 | 149 | <0.5 | 2 | <0.5 |
| electrodeionization | | | | | | |
| Degree of removal (%) | 97.5 | 98.3 | 99.4 | 99.4 | 99.7 | 99.6 |

The results show that the process according to the invention makes it possible to significantly reduce the organic and inorganic impurities, in particular the content of total organic carbon (TOC), the nitrates, the sodium, the silicon, the chromium and the iron.

### Example 2

Crude aqueous hydrogen peroxide solution at 60% by weight in water, resulting from an anthraquinone process, is subjected to filtration on membranes.

The aqueous hydrogen peroxide solution is, in a first step, purified by two treatments on a polyamide reverse osmosis membrane, at a temperature of 15° C. and a pressure of 30 bar.

The volume concentration factor (VCF) during the first treatment on a membrane is 8 and the volume concentration factor during the second treatment on a membrane is 5.

The permeate originating from the two membrane treatments is then purified with an electrodeionization treatment, as in example 1, but this time with a diluate feed flow rate of 10 l/h and a concentrate flow rate of 1 l/h.

All of the treatments (two treatments on a membrane and the electrodeionization treatment) are carried out at a temperature of 15° C.

The quantitative determination of the elements shown in the table below leads to the following results:

TABLE 2

| | TOC | NO₃⁻ | Na | Cr | Fe | Si |
|---|---|---|---|---|---|---|
| Purification method | (ppm) | (ppm) | (ppb) | (ppb) | (ppb) | (ppm) |
| Aqueous hydrogen peroxide solution | 276 | 17.4 | 25 000 | 142 | 583 | 133 |
| after production process and | | | | | | |
| before purification (crude product) | | | | | | |
| Diluate resulting from the | 4 | <0.3 | 20 | <0.5 | <0.5 | <0.5 |
| electrodeionization | | | | | | |
| Degree of removal (%) | 98.6 | 98.3 | 99.9 | 99.4 | 99.9 | 99.6 |

The results show that the process according to the invention makes it possible to significantly reduce the organic and inorganic impurities, in particular the content of total organic carbon (TOC), the nitrates, the sodium, the silicon, the chromium and the iron.

1. A process for the purification of an aqueous solution containing hydrogen peroxide, comprising at least one treatment on a reverse osmosis membrane and at least one electrodeionization treatment, the membrane being chosen from the group consisting of a membrane of polyamide, cellulose, polypiperazine, polyacrylonitrile and polysulfone type.

2. The process as claimed in claim 1, wherein the reverse osmosis membrane is a membrane of polyamide type.

3. The process as claimed in claim 1, wherein the permeation flux during the treatment on a membrane varies from 10 to 200 l/h·m².

4. The process as claimed in claim 1, wherein it successively comprises at least one treatment on a reverse osmosis membrane and at least one electrodeionization treatment.

5. The process as claimed in claim 1, wherein the volume concentration factor varies from 1.1 to 15.

6. The process as claimed in claim 1, wherein the electrodeionization treatment is carried out by means of an electrodeionization module comprising an anode (1), a cathode (2), a purification compartment (3), arranged between two concentration compartments (4) and (5), the walls of which are provided with a first anion-exchange membrane (6) and a first cation-exchange membrane (7).

7. The process as claimed in claim 1, wherein the treatment on a membrane and the electrodeionization treatment are carried out at a temperature of less than 20° C.

8. The process as claimed in claim 1, wherein it comprises one or two treatments on a reverse osmosis membrane.

9. The process as claimed in claim 1, wherein it comprises at least two treatments on a reverse osmosis membrane.

10. The process as claimed in claim 1, wherein the aqueous hydrogen peroxide solution, after purification, comprises a nitrate content of less than 3 ppm.

11. The process as claimed in claim 1, wherein it does not comprise, before the treatment(s) on a reverse osmosis membrane, a stage of treatment on an ion-exchange resin.

12. A process for the preparation of an aqueous hydrogen peroxide solution, comprising:
at least the production of an aqueous hydrogen peroxide solution,
at least one treatment on a membrane of polyamide, cellulose, polypiperazine, polyacrylonitrile and polysulfone type, and at least one electrodeionization treatment of the aqueous hydrogen peroxide solution.

13. An aqueous hydrogen peroxide solution obtained by a purification process, according to claim 1.

14. The aqueous hydrogen peroxide solution as claimed in claim 13, wherein the nitrate content is less than 3 ppm.

15. A method comprising using the aqueous hydrogen peroxide solution according to claim 13, in the field of electronics.
